(19) United States
(12) Patent Application Publication
(10) Pub. No.: US 2026/0247489 A1
(43) Pub. Date: Aug. 20, 2026

(54) NON-3GPP AMBIENT INTERNET OF THINGS

(71) Applicant: CABLE TELEVISION LABORATORIES, INC, Louisville, CO (US)

(72) Inventors: Rahil GANDOTRA, Boulder, CO (US); Mohammed ZOUROB, Castle Pines, CO (US)

(73) Assignee: CABLE TELEVISION LABORATORIES, INC, Louisville, CO (US)

(21) Appl. No.: 19/539,857

(22) Filed: Feb. 13, 2026

Related U.S. Application Data
(60) Provisional application No. 63/758,415, filed on Feb. 14, 2025.

(51) Int. Cl. H04W 88/02; H04W 76/11; H04W 76/27

(52) U.S. Cl. CPC H04W 88/02; H04W 76/11; H04W 76/27

(57) ABSTRACT

Various systems, apparatuses, and methods for providing various indirect ambient internet of things (AIoT) services using various intermediate devices are provided. An AIoT function (AIoTF) receives a request for an AIoT service from a network exposure function (NEF). The AIoTF determines that one or more AIoT devices require indirect access via a user equipment (UE). The AIoTF transmits an inventory request message to the UE. The UE communicates with the one or more AIoT devices using ambient or backscatter signaling. The UE functions as a reader device for the one or more AIoT devices. The UE determines one or more inventory results and transmits the one or more inventory results to the AIoTF via the radio access node (RAN) using radio resource control (RRC) signal. The AIoTF exposes the one or more inventory results to the NEF.

### CROSS REFERENCE TO RELATED APPLICATIONS

This application claims the benefit of U.S. provisional application no. 63/758,415 filed on February 14, 2025 which is incorporated by reference as if fully set forth.

### BACKGROUND OF THE INVENTION

Ambient internet of things (IoT) is a new class of IoT devices that are primarily powered by harvesting ambient energy from radio waves, light, motion, heat, and/or any other viable ambient energy source. Ambient IoT is an extension of the conventional IoT, and is expected to play a significant role in the future of connected devices. Third generation partnership project (3GPP) is working on an Ambient IoT framework including radio access network (RAN) aspects and service and system aspects (SA). However, non-3GPP access nodes and/or spectrum have not been considered within the 3GPP Ambient IoT framework.

### SUMMARY OF THE INVENTION

In various implementations of the present disclosure, a method performed by a user equipment (UE) is provided. The method comprises receiving an ambient internet of things (AIoT) inventory request message from an AIoT function (AIoTF). The method comprises configuring, based on the AIoT inventory request message, one or more ambient power (AMP) access point (AP) station (STA) functions. The method comprises receiving one or more AIoT AMP physical layer protocol data units (PPDUs) from one or more AIoT devices using the one or more AMP AP STA functions. The method comprises decoding the one or more AIoT AMP PPDUs to determine one or more inventory results. The method comprises reconstructing, based on the one or more inventory results, one or more AIoT non-access stratum (NAS) messages associated with the one or more AIoT devices, or relaying the one or more AIoT NAS messages received from the one or more AIoT devices. The method comprises transmitting the one or more AIoT NAS messages to the AIoTF.

In an implementation, the UE communicates with the AIoTF via: a radio resource control (RRC) signaling between the UE and a next-generation radio access network (NG-RAN), a next-generation application protocol (NGAP) between the NG-RAN and an access and mobility management function (AMF), and a service-based interface (SBI) between the AMF and the AIoTF.

In an implementation, the UE communicates with the one or more AIoT devices using Wi-Fi AMP signaling or backscatter signaling.

In an implementation, wherein the AIoT inventory request message comprises: listening window configuration information, energy emission configuration information, one or more decoding parameters associated with the one or more AIoT signals, or identification information associated with the one or more AIoT devices.

In an implementation, the UE terminates a Wi-Fi medium access control (MAC) layer and physical (PHY) layer for the one or more AIoT devices.

In an implementation, the method further comprises receiving one or more commands from the AIoTF via RRC signaling. The method further comprises transmitting the one or more commands to the one or more AIoT devices via Wi-Fi AMP signaling or backscatter signaling.

In an implementation, the commands are indicative of performing, on the one or more AIoT devices, one or more of: an inventory operation, a read operation, a write operation, or a disable operation.

In an implementation, the method further comprises configuring an AMP energizer to transmit one or more wireless power transfer (WPT) waveforms or one or more excitation waveforms to the one or more AIoT devices to enable backscatter signaling.

In various implementations of the present disclosure, a user equipment (UE) comprising a transceiver and a processor is provided. The transceiver and the processor are configured to receive an ambient internet of things (AIoT) inventory request message from an AIoT function (AIoTF). The transceiver and the processor are configured to configure, based on the AIoT inventory request message, one or more ambient power (AMP) access point (AP) station (STA) functions. The transceiver and the processor are configured to receive one or more AIoT AMP physical layer protocol data units (PPDUs) from one or more AIoT devices using the one or more AMP AP STA functions. The transceiver and the processor are configured to decode the one or more AIoT AMP PPDUs to determine one or more inventory results. The transceiver and the processor are configured to reconstruct, based on the one or more inventory results, one or more AIoT non-access stratum (NAS) messages associated with the one or more AIoT devices. In an embodiment, the transceiver and the processor are configured to relay the one or more NAS messages received from the one or more AIoT devices. The transceiver and the processor are configured to transmit the one or more AIoT NAS messages to the AIoTF.

In an implementation, the UE communicates with the AIoTF via: a radio resource control (RRC) signaling between the UE and a next-generation radio access network (NG-RAN), a next-generation application protocol (NGAP) between the NG-RAN and an access and mobility management function (AMF), and a service-based interface (SBI) between the AMF and the AIoTF.

In an implementation, the UE communicates with the one or more AIoT devices using Wi-Fi AMP signaling or backscatter signaling.

In an implementation, the AIoT inventory request message comprises: listening window configuration information, energy emission configuration information, one or more decoding parameters associated with the one or more AIoT signals, or identification information associated with the one or more AIoT devices.

In an implementation, the UE terminates a Wi-Fi medium access control (MAC) layer and physical (PHY) layer for the one or more AIoT devices.

In an implementation, the transceiver and the processor are further configured to receive one or more commands from the AIoTF via RRC signaling. The transceiver and the processor are further configured to transmit the one or more commands to the one or more AIoT devices via Wi-Fi AMP signaling or backscatter signaling.

In an implementation, the commands are indicative of performing, on the one or more AIoT devices, one or more of: an inventory operation, a read operation, a write operation, or a disable operation.

In an implementation, the transceiver and the processor are further configured to configure an AMP energizer to transmit one or more wireless power transfer (WPT) waveforms or one or more excitation waveforms to the one or more AIoT devices to enable backscatter signaling.

In various implementations of the present disclosure, a method performed by a network device is provided. The method comprises receiving, from a network exposure function (NEF), a request for an ambient internet of things (AIoT) service associated with one or more AIoT devices. The method comprises determining that the one or more AIoT devices require indirect access. The method comprises selecting a user equipment (UE) authorized to operate as a reader for the one or more AIoT devices. The method comprises transmitting an AIoT inventory request message to the UE. The method comprises receiving, from the UE, one or more AIoT non-access stratum (NAS) messages comprising one or more inventory results associated with the one or more AIoT devices. The method comprises transmitting the one or more inventory results to the NEF.

In an implementation, the AIoT inventory request message comprises: listening window configuration information, energy emission configuration information, one or more decoding parameters associated with one or more AIoT signals, or identification information associated with the one or more AIoT devices.

In an implementation, the method comprises retrieving AIoT device profile information from a unified data management (UDM) or AIoT data management (ADM). The method comprises generating the AIoT inventory request message based on the AIoT device profile information.

In an implementation, the network device functions as an AIoT function (AIoTF).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and 5G core (5GC);

FIG. 4 illustrates an example of a protocol stack for a user plane and a control plane;

FIG. 5 is a schematic architectural diagram illustrating a first topology;

FIG. 6 is a schematic architectural diagram illustrating a second topology;

FIG. 7A is a schematic architectural diagram illustrating a first example of a third topology;

FIG. 7B is a schematic architectural diagram illustrating a second example of a third topology;

FIG. 8 is a schematic architectural diagram of a fourth topology;

FIG. 9A is a schematic architectural diagram illustrating a first example of a second topology including a residential gateway (RG) according to one or more implementations of the present disclosure;

FIG. 9B is a schematic architectural diagram illustrating a second example of a second topology including a RG according to one or more implementations of the present disclosure;

FIG. 9C is a schematic architectural diagram illustrating a third example of a second topology including a wireline access gateway function (W-AGF) according to one or more implementations of the present disclosure;

FIG. 9D is a schematic architectural diagram illustrating a fourth example of a second topology including a non-3GPP interworking function (N3IWF) and/or trusted non-3GPP gateway function (TNGF) N3IWF/TNGF according to one or more implementations of the present disclosure;

FIG. 10A is a schematic architectural diagram illustrating a first example of a third topology including a RG according to one or more implementations of the present disclosure;

FIG. 10B is a schematic architectural diagram illustrating a second example of a third topology including a RG according to one or more implementations of the present disclosure;

FIG. 11 is a schematic architectural diagram illustrating a fourth topology including a RG according to one or more implementations of the present disclosure;

FIG. 12 is a schematic architectural diagram illustrating a user plane architecture for a second topology is shown according to one or more implementations of the present disclosure;

FIG. 13 is a schematic architectural diagram illustrating a protocol stack for a user plane architecture for a second topology according to one or more implementations of the present disclosure;

FIG. 14 is a schematic architectural diagram illustrating a protocol stack for radio resource control (RRC) for a second topology according to one or more implementations of the present disclosure;

FIG. 15 is a schematic architectural diagram illustrating an AIoT architecture according to one or more implementations of the present disclosure;

FIG. 16 is a schematic architectural diagram illustrating a protocol stack for Wi-Fi–based AIoT devices is shown according to one or more implementations of the present disclosure;

FIG. 17 is a schematic call flow diagram illustrating an AIoT inventory procedure according to one or more implementations of the present disclosure;

FIG. 18 is a schematic block diagram illustrating communication between a cellular UE reader device and a Wi-Fi AMP device using an AMP energizer according to one or more implementations of the present disclosure;

FIG. 19 is a flowchart illustrating a method performed by a UE according to one or more implementations of the present disclosure; and

FIG. 20 is a flowchart illustrating a method performed by an AIoTF according to one or more implementations of the present disclosure.

### DETAILED DESCRIPTION

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., GPS, GLONASS, etc., which may or may not be integrated with the processor and/or transceiver), button (e.g., for controlling the specific function of one or more aspects of the device). These components may be operably connected to one another, meaning that there may be a direct connection or an indirect connection to one or more of the components.

A UE may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like.

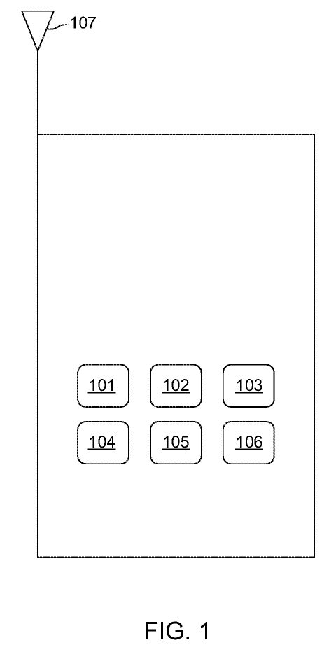

FIG. 1 is an illustration of an example device. In one case, the device may be a User Equipment (UE) suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission, and demodulate signals for reception. The UE may be capable of full duplex operation, where there is transmission and reception of some or all signals may be concurrent and/or simultaneous (e.g., different timing/spacing for UL or DL).

Different radio access technologies may be used with one or more transceivers (e.g., 802.11, WCDMA, CDMA2000, GSM, LTE, LTE-A, LTE-A Pro, NR etc.).

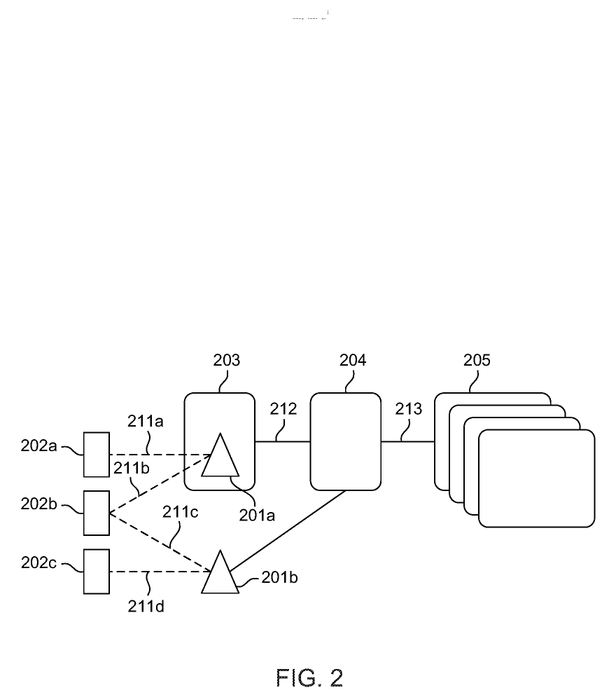

FIG. 2 illustrates an example communication system. This example may be used to illustrate multiple wireless protocols. For all wireless protocols, there may be mobile or stationary devices (e.g., 202a, 202b, 202c, such as a UE) that connect to a base station 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points).

Generally, a communication system may use a combination of wired and wireless connections at different points in the system. One or more wireless technologies may (e.g., channel access methods) include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that uses more than one type of base station (e.g., an eNB and a gNB).

In one case, the communication system may include a radio access network (RAN) 203, a core network 204, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on E-UTRA (e.g., LTE, etc.). The communication system may handle data transmission from the UE 202a. The data may have varying quality of service (QoS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same RAT as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF), routing of control plane information towards Access and Mobility Management Function (AMF), and the like. The gNB(s) may communicate with one another over an Xn interface.

Not shown (e.g., but still possibly part of one or more example scenarios described herein), the CN may include one or more AMF, one or more UPF, one or more Session Management Function (SMF), and/or one or more Data Networks (DNs). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the internet protocol (IP) in the TCP/IP internet protocol suite.

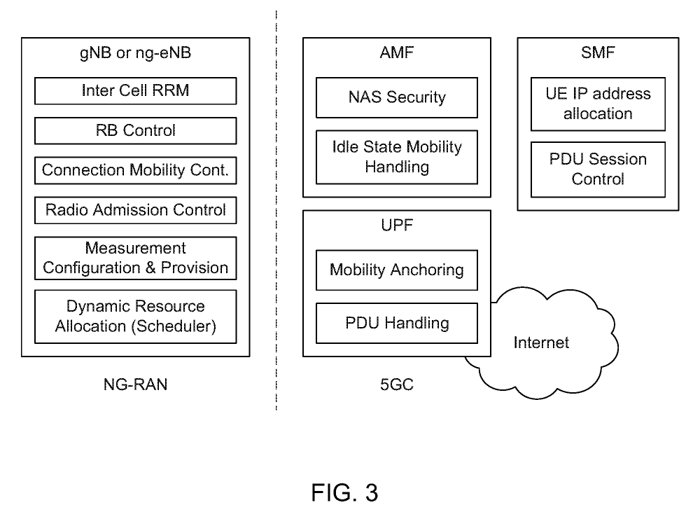

FIG. 3 illustrates an example of a functional split between the NG-RAN and 5GC. The AMF may be connected to one or more gNB in the RAN via an N2 interface and may serve as a control node. For example, the AMF may be responsible for authenticating a support of the UE for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

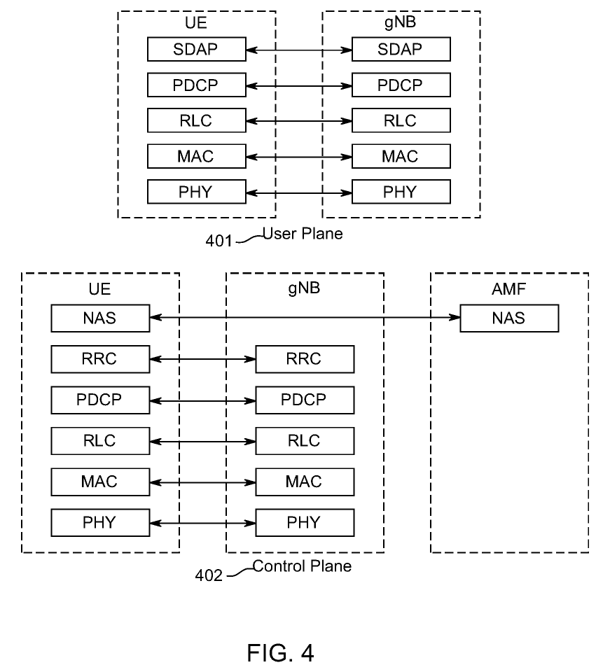

FIG. 4 illustrates an example of a protocol stack for the user plane and control plane. The user plane protocol stack 401 and the control plane stack 402. A higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 1 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Third generation partnership project (3GPP) has specified three types of Ambient IoT devices. Type A devices have no energy storage, no independent signal generation and/or amplification, e.g. perform backscattering transmission. Type B devices have an energy storage (e.g., a battery), no independent signal generation, e.g. perform backscattering transmission. Use of stored energy can include amplification for one or more reflected signals. Type C devices have energy storage, has independent signal generation, e.g., have one or more active radio frequency (RF) components for transmission. The 3GPP describes four types of Ambient IoT connectivity topologies.

Typically, Ambient IoT devices are ultra-low-power or battery-less devices that operate by harvesting energy from their surrounding environment, such as but not limited to ambient radio frequency (RF) signals, light, vibration, and/or thermal gradients etc. The Ambient IoT devices communicate intermittently using backscatter and/or other energy efficient transmission techniques. The Ambient IoT devices are typically characterized by minimal computational capability, sporadic connectivity, and/or small data payloads, yet the Ambient IoT devices can be deployed at massive scale and embedded into everyday objects, infrastructure, or environments. In the context of standardized cellular systems, Ambient IoT has emerged as a key enabler for large-scale sensing and monitoring use cases, where traditional battery-powered IoT devices are impractical due to cost, maintenance, or form-factor constraints. Cellular Ambient IoT frameworks aim to provide network-assisted device discovery, identification, authentication, data collection, and/or lifecycle management etc. while accommodating the unique power and signaling limitations of such Ambient IoT devices.

Integrating Wi-Fi-based Ambient IoT devices with the cellular core Ambient IoT framework provides significant architectural, operational, and ecosystem-level benefits. Wi-Fi ambient IoT devices can leverage the ubiquity of Wi-Fi infrastructure and ambient Wi-Fi transmissions for energy harvesting and backscatter-based communications, while the cellular core offers a unified, scalable control and service plane for device onboarding, authorization, data routing, and/or application exposure etc. Such integration enables cellular-grade security, identity management, and policy enforcement to be extended to Wi-Fi ambient devices without requiring each device to implement full cellular protocol stacks. Additionally, the cellular core can aggregate ambient IoT data from heterogeneous access technologies, support seamless interworking with existing cellular Ambient IoT services, and expose standardized APIs to vertical applications. This convergence allows network operators and service providers to deploy and manage large populations of Wi-Fi-based Ambient IoT devices as part of a common Ambient IoT ecosystem, reducing fragmentation, improving reliability and coverage, and accelerating adoption of ambient sensing solutions across smart infrastructure, industrial monitoring, and consumer environments.

In 3GPP Ambient IoT, a second topology refers to an architecture in which Ambient IoT devices communicate indirectly with the cellular network via an intermediate node, rather than establishing a direct radio interface with a cellular base station. In this topology, the Ambient IoT device employs ultra-low-power communication mechanisms, such as backscatter or energy-efficient short-range signaling, toward a nearby intermediate node, often a user equipment (UE), relay, integrated access and backhaul (IAB) node or repeater that has sufficient power, processing capability, and cellular connectivity. The intermediate node terminates the ambient communication, performs functions such as signal detection, decoding, aggregation, and potentially preliminary authentication or filtering, and then forwards the resulting data and device context to the cellular core using conventional cellular signaling and user-plane mechanisms. The second topology is particularly well suited for battery-less or severely power-constrained devices, as the second topology offloads complexity from the Ambient IoT device while allowing the cellular core to maintain centralized control, identity management, and service exposure for large populations of Ambient IoT devices deployed in proximity to user equipment, infrastructure nodes, and/or fixed gateways etc.

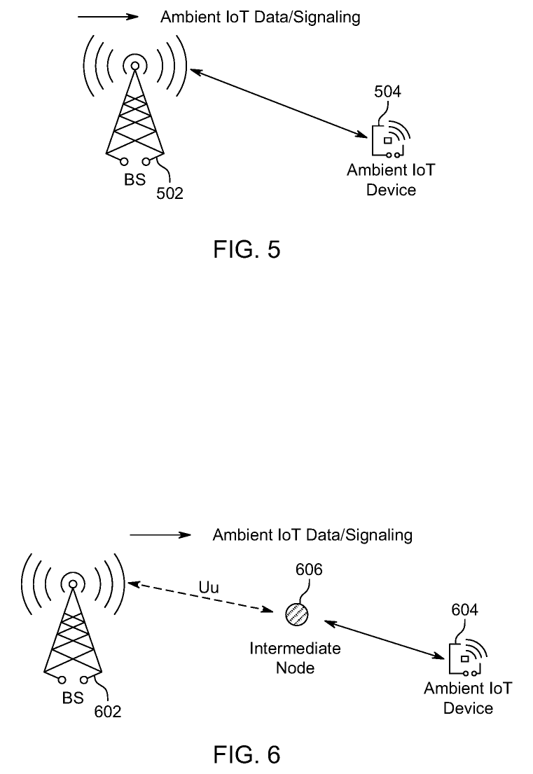

Referring now to FIG. 5, a schematic architectural diagram of a first topology is shown. The first topology includes a base station 502 and an Ambient IoT device 504. In the first topology, the Ambient IoT device 504 directly and bidirectionally communicates with the base station 502. The communication between the base station 502 and the Ambient IoT device 504 includes ambient IoT data and/or signaling. In an example, in the first topology, a base station transmitting to the Ambient IoT device 504 may be different from a base station receiving from the Ambient IoT device 504. In an example, the base station 502 may be a transmitting base station or a receiving base station or a transmit/receive base station.

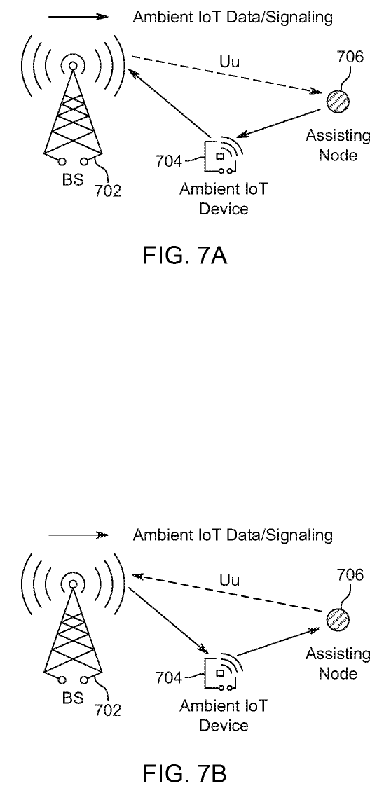

Referring now to FIG. 6, a schematic architectural diagram of a second topology is shown. The second topology includes a base station 602, an Ambient IoT device 604, and an intermediate node 606. In the second topology, the Ambient IoT device 604 communicates bidirectionally with the intermediate node 606 between the Ambient IoT device 604 and the base station 602. In the second topology, the intermediate node 606 may be a relay node, integrated access and backhaul (IAB) node, a user equipment (UE), and/or a repeater, etc. which is capable of ambient IoT communication. The intermediate node 606 transfers ambient IoT data and/or signaling between the base station 602 and the Ambient IoT device 604.

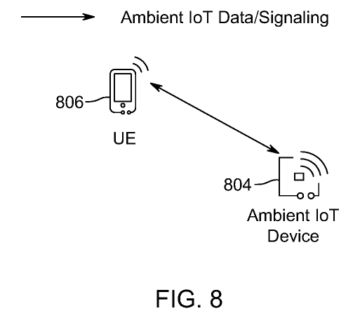

Referring now to FIG. 7A, a schematic architectural diagram of a first example of a third topology is shown.

Referring now to FIG. 7B, a schematic architectural diagram of a second example of a third topology is shown.

The third topology includes a base station 702, an Ambient IoT device 704, and an assisting node 706.

In an example, in the third topology, the Ambient IoT device 704 transmits data and/or signaling to the base station 702, and receives data and/or signaling from the assisting node 706. In an example, in the third topology, the Ambient IoT device 704 receives data and/or signaling from the base station 702 and transmits data and/or signaling to the assisting node 706. In the third topology, the assisting node 706 can be a relay node, an IAB node, a UE, and/or a repeater, etc. which is capable of ambient IoT communication.

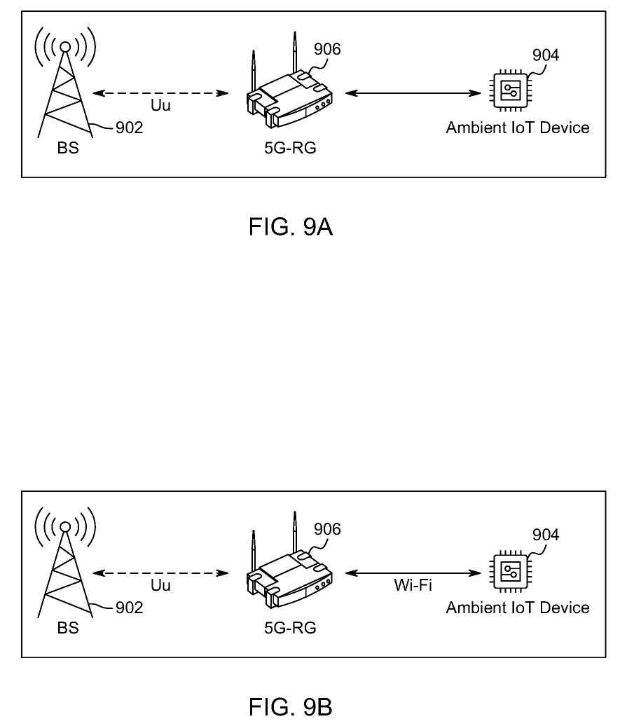

Referring now to FIG. 8, a schematic architectural diagram of a fourth topology is shown. The fourth topology includes an Ambient IoT device 804 and a UE 806. In the fourth topology, the Ambient IoT device 804 communicates bidirectionally with the UE 806. The communication between the UE 806 and the Ambient IoT device 804 includes ambient IoT data and/or signaling.

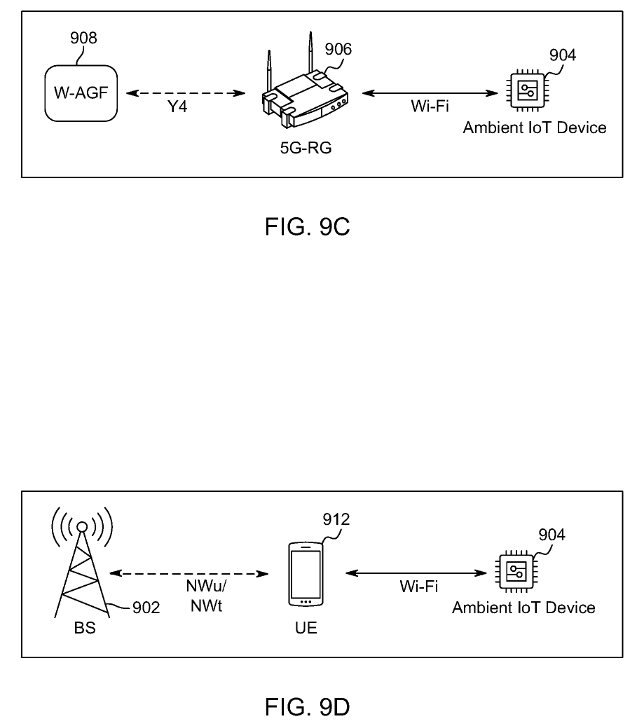

Referring now to FIG. 9A, a schematic architectural diagram of a first example of a second topology including a residential gateway (RG) is shown according to one or more implementations of the present disclosure. The second topology includes a base station 902, an Ambient IoT device 904, and a RG 906. The RG 906 can act as an intermediate node transferring ambient IoT data and/or signaling between the base station 902 and the Ambient IoT device 904. In an embodiment, the RG 906 is a fifth generation (5G) RG (5G-RG) connected to a 5G core network, via a fixed broadband access, a cable access, and/or a NG-RAN etc., for example. In an embodiment, the RG 906 is a sixth generation (6G) RG connected to a 6G core network, via the fixed broadband access, the cable access, and/or the 6G-RAN etc., for example.

Referring now to FIG. 9B, a schematic architectural diagram of a second example of a second topology including a RG is shown according to one or more implementations of the present disclosure. The second topology includes a base station 902, an Ambient IoT device 904, and a RG 906. The RG 906 can use Wi-Fi to communicate with the Ambient IoT device 904 transferring ambient IoT data and/or signaling between the base station 902 and the Ambient IoT device 904.

Referring now to FIG. 9C, a schematic architectural diagram of a third example of a second topology including a wireline access gateway function (W-AGF) is shown according to one or more implementations of the present disclosure. In FIG. 9C, the second topology includes an Ambient IoT device 904, a RG 906, and a W-AGF 908. The RG 906 can use Wi-Fi to communicate with the Ambient IoT device 904 transferring ambient IoT data and/or signaling between the W-AGF 908 and the Ambient IoT device 904.

Referring now to FIG. 9D, a schematic architectural diagram of a fourth example of a second topology is shown according to one or more implementations of the present disclosure. The second topology includes an Ambient IoT device 904, a base station 902, and a UE 912. The UE 912 can use Wi-Fi to communicate with the Ambient IoT device 904 transferring ambient IoT data and/or signaling between the base station 902 and the Ambient IoT device 904.

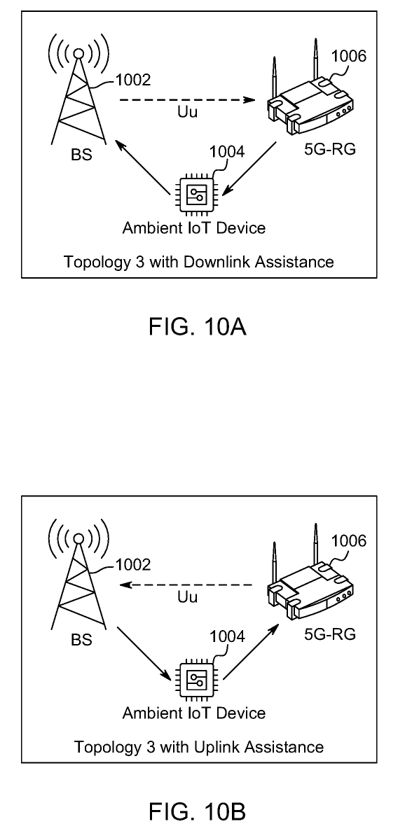

Referring now to FIG. 10A, a schematic architectural diagram of a first example of a third topology including a RG is shown according to one or more implementations of the present disclosure. FIG. 10A shows the third topology with downlink assistance.

Referring now to FIG. 10B, a schematic architectural diagram of a second example of a third topology including a RG is shown according to one or more implementations of the present disclosure. FIG. 10B shows the third topology with uplink assistance.

The third topology includes a base station 1002, an Ambient IoT device 1004, and a RG 1006. In an example, in the third embodiment, the Ambient IoT device 1004 transmits data and/or signaling to the base station 1002, and receives data and/or signaling from the RG 1006. In an example, in the third embodiment, or the Ambient IoT device receives data/signaling from the base station 1002 and transmits data and/or signaling to the RG 1006. In an embodiment, the RG 1006 is a 5G-RG connected to a 5G core network. In an embodiment, the RG 1006 is connected to a 6G core network.

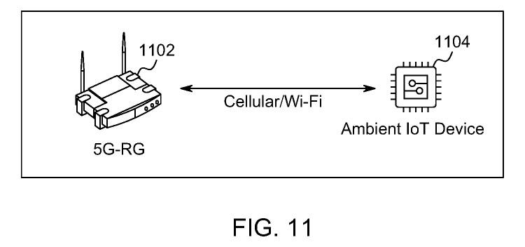

Referring now to FIG. 11, a schematic architectural diagram of a fourth topology including a RG is shown according to one or more implementations of the present disclosure. The fourth topology includes a RG 1102 and an Ambient IoT device 1104. The Ambient IoT device 1104 communicates bidirectionally with the RG 1102. The communication between a UE and the Ambient IoT device 1104 includes ambient IoT data and/or signaling. The communication between the RG 1102 and the Ambient IoT device 1104 can be over Wi-Fi. In an embodiment, the RG 1102 is a 5G-RG connected to a 5G core network. In an embodiment, the RG 1102 is connected to a 6G core network.

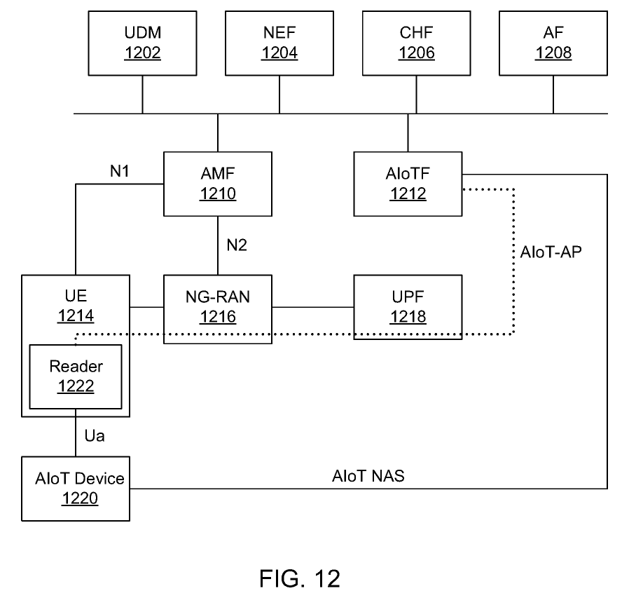

Referring now to FIG. 12, a schematic architectural diagram of a user plane architecture for a second topology is shown according to one or more implementations of the present disclosure. The user plane architecture includes a unified data management (UDM) 1202, a network exposure Function (NEF) 1204, a charging function (CHF) 1206, an application function (AF) 1208, an access and mobility management function (AMF) 1210, an Ambient IoT function (AIoTF) 1212, a UE 1214, a next generation radio access network (NG-RAN) 1216, a user plane function (UPF) 1218, and an AIoT device 1220. The UE 1214 includes a reader 1222.

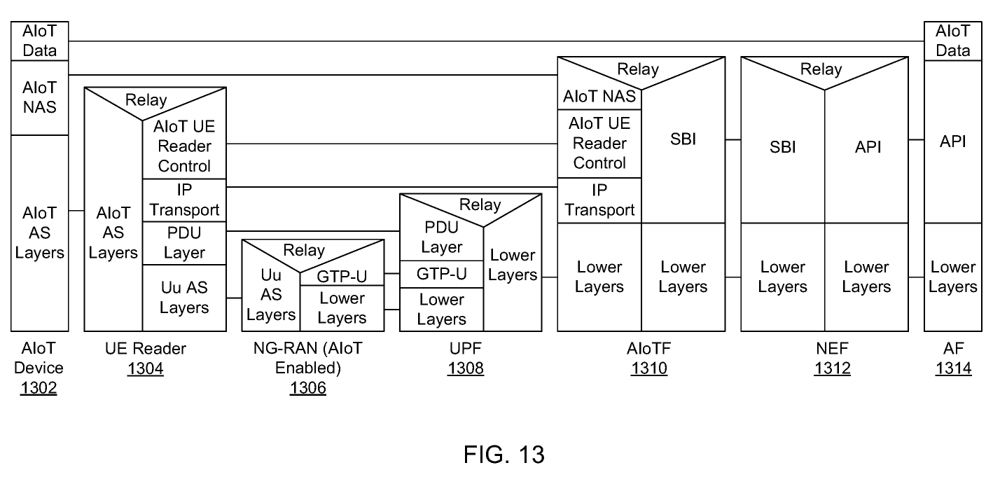

As shown in FIG. 12, the reader 1222 connects to the AIoTF 1212 based on the AIoT application protocol (AIoT-AP) using an IP PDU session between the UE 1214 and the UPF 1218 as transport. A related protocol stack is shown in FIG. 13.

Referring now to FIG. 13, a schematic architectural diagram of a protocol stack for a user plane architecture for a second topology is shown according to one or more implementations of the present disclosure. FIG. 13 shows an AIoT device 1302, a UE reader device 1304, an AIoT enabled NG-RAN 1306, a UPF 1308, an AIoTF 1310, an NEF 1312, and an AF 1314. The protocols shown in FIG. 13 include but are not limited to AIoT non-access stratum (NAS) protocol, AIoT AS layers, AIoT UE reader control, internet protocol (IP) transport, protocol data unit (PDU) layer, Uu AS layers, GPRS tunneling protocol - user plane (GTP-U), and lower layers etc.

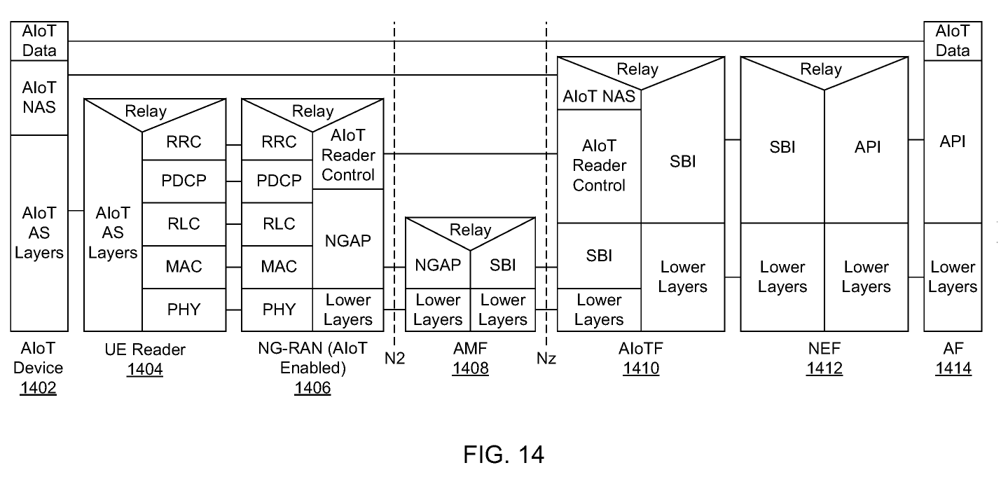

Referring now to FIG. 14, a schematic architectural diagram of a protocol stack for radio resource control (RRC) for a second topology is shown according to one or more implementations of the present disclosure. FIG. 14 shows an AIoT device 1402, a UE reader device 1404, an AIoT enabled NG-RAN 1406, an AMF 1408, an AIoTF 1410, an NEF 1412, and an AF 1414. The protocols shown in FIG. 14 include but are not limited to AIoT NAS, AIoT AS layers, RRC, packet data convergence protocol (PDCP), radio link control (RLC), medium access control (MAC), physical (PHY) layer, next generation application protocol (NGAP), service-based interface (SBI), and/or AIoT reader control etc.

In FIG. 14, messages between the UE reader device 1404 and the AIoTF 1410 are delivered using RRC between the UE reader device 1404 and RRC and NGAP between a base station (gNB) and the AMF 1408, and using the SBI interface between the AMF 1408 and the AIoTF 1410.

In one or more implementations of the present disclosure, an extended 3GPP Ambient IoT framework to include non-3GPP access nodes and spectrum is provided. In an example, the extended 3GPP Ambient IoT framework may allow multiple system operators (MSOs) with converged networks to leverage their fixed-network infrastructure (including both wireline and Wi-Fi assets) to provide one or more Ambient IoT services. In an example, the extended 3GPP Ambient IoT framework may allow MSOs to utilize an unlicensed spectrum to provide one or more services in addition to connectivity.

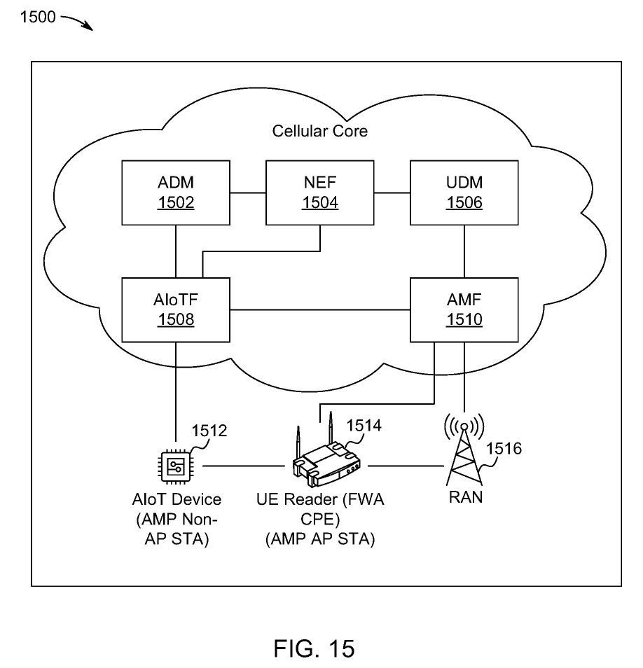

Referring now to FIG. 15, a schematic architectural diagram of an AIoT architecture 1500 is shown according to one or more implementations of the present disclosure. The AIoT architecture 1500 includes an AIoT data management (ADM) 1502, a NEF 1504, a UDM 1506, an AIoTF 1508, an AMF 1510, an AIoT device 1512, a UE reader device 1514, and a RAN 1516.

The AIoT architecture 1500 includes a dual-role intermediate device (e.g., the UE reader device 1514) that enables Wi-Fi–based Ambient IoT devices (e.g., the AIoT device 1512) to be incorporated into a cellular Ambient IoT framework. The Wi-Fi AIoT device (e.g., the AIoT device 1512) operating as an ambient power non-access point station (AMP non-AP STA) uses ultra-low-power IEEE 802.11–based ambient and/or backscatter signaling toward a nearby Wi-Fi–capable node (e.g., the UE reader device 1514). The UE reader device 1514 node functions as an AMP AP STA toward the AIoT device 1512, terminating the Wi-Fi ambient signaling, performing detection and/or decoding of ambient transmissions. Simultaneously, the same node operates as the UE reader device 1514 toward the cellular network, establishing conventional cellular connectivity to the cellular core.

Within the cellular core, the UE reader device 1514 interfaces with Ambient IoT–specific and common 5G and/or 6G core network functions, including the AIoTF 1508, the ADM 1502, the NEF 1504, the UDM 1506, and the AMF 1510. The AIoTF 1508 coordinates one or more Ambient IoT–specific procedures such as but not limited to device identification, data ingestion, and/or context handling, while the ADM 1502 supports provisioning and lifecycle management of ambient devices. The NEF 1504 exposes Ambient IoT data and/or capabilities to external applications, the UDM 1506, and/or the AMF 1510 provide subscriber data management, authentication context, and/or mobility and/or control-plane anchoring for the UE reader device 1514. Through this dual-role design, the AIoT architecture 1500 cleanly decouples ultra-low-power Wi-Fi ambient communications from cellular signaling complexity, while enabling Wi-Fi-based Ambient IoT devices to benefit from cellular-grade security, management, and/or application enablement via the cellular core.

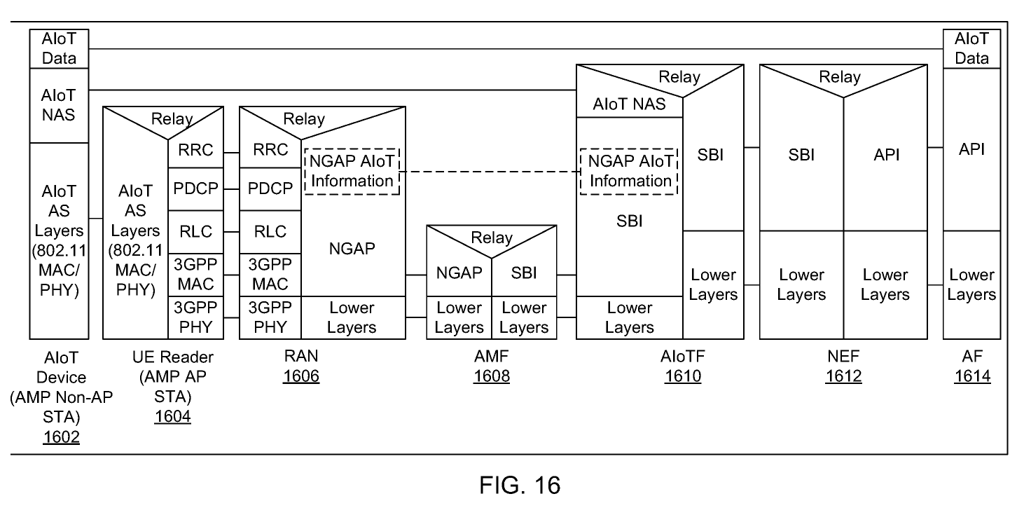

Referring now to FIG. 16, a schematic architectural diagram of a protocol stack for Wi-Fi–based AIoT devices is shown according to one or more implementations of the present disclosure. FIG. 16 shows an AIoT device 1602, a UE reader device 1604, a RAN 1606, an AMF 1608, an AIoTF 1610, a NEF 1612, and an AF 1614. The protocols shown in FIG. 16 include but are not limited to AIoT NAS, AIoT AS layers, RRC, PDCP, RLC, MAC, PHY layer, NGAP, NGAP AIoT information, SBI, and AIoT reader control etc.

FIG. 16 depicts a layered protocol stack that enables the Wi-Fi–based AIoT device 1602 to interwork with the 3GPP cellular core through an intermediate node (the UE reader device 1604) function. The AIoT device 1602 (AMP non-AP STA) implements only Ambient IoT application and/or access-stratum layers over IEEE 802.11 MAC/PHY, reflecting its ultra-low-power and limited capability profile. The Ambient IoT data and lightweight NAS-like signaling are conveyed using Wi-Fi–based ambient and/or backscatter mechanisms towards the UE reader device 1604 (AMP AP STA).

The UE reader device 1604 terminates the 802.11 MAC/PHY and hosts the AIoT access and relay functions, while simultaneously running a full 3GPP access stack (PHY, MAC, RLC, PDCP, RRC) toward the cellular network. The AIoT information is encapsulated and/or forwarded via standard 3GPP control interfaces, with AIoT-specific context carried, for example, within NGAP signaling toward the AMF 1608. Beyond the access network, the UE reader device 1604 interacts with core network functions using service-based interfaces (SBI), allowing AIoT NAS information and data to be delivered to one or more Ambient IoT functions and exposed to applications via APIs.

The AIoT device 1602 supports AIoT NAS protocol with the AIOTF and 802.11bp AMP signaling with the UE reader device 1604 (AMP AP STA) (e.g., AMP non-AP STA).

The UE reader device 1604 is a UE that supports functionality with AIOTF and the 802.11bp AMP signaling with the AIoT device 1602 (AMP non-AP STA) (e.g., AMP AP STA).

The UE (e.g., the UE reader device 1604) subscription information in the UDM is extended to include whether the UE (e.g., the UE reader device 1604) is allowed to operate as a UE reader for the Wi-Fi AIoT devices.

The protocol stack for Wi-Fi–based AIoT devices supports one or more AIoT services.

In an example, an inventory service is used to discover the Wi-Fi AIoT devices (AMP non-AP STAs).

In an example, a command service is used to perform one or more types of command service operations supported for the Wi-Fi AIoT devices (AMP non-AP STAs), such as but not limited to read, write, and/or disable etc.

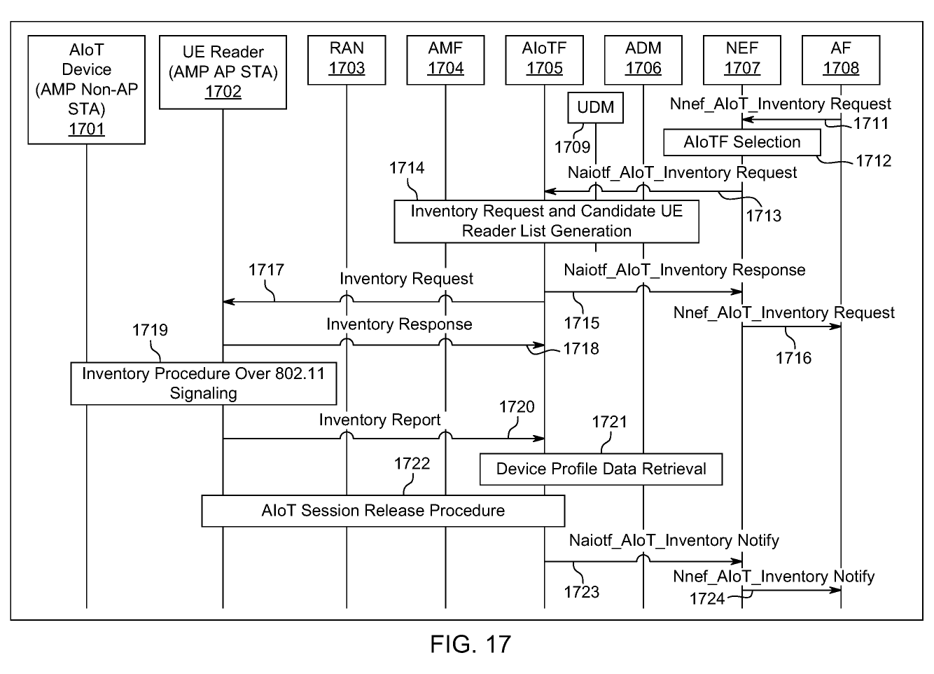

Referring now to FIG. 17, a schematic call flow diagram of an AIoT inventory procedure is shown according to one or more implementations of the present disclosure. The AIoT inventory procedure is performed by one or more of: an AIoT device 1701, a UE reader device 1702, a RAN 1703, an AMF 1704, an AIoTF 1705, an ADM 1706, a NEF 1707, an AF 1708, and a UDM 1709.

In an example, one or more steps in the AIoT inventory procedure shown in FIG. 17 may be based on clause 6.2.2 of 3GPP TS 22.369. In an example, in the AIoT inventory procedure the Wi-Fi–based AIoT device 1701 may connect to the cellular core indirectly via a UE reader device 1702 (e.g., IEEE 802.11 AMP AP STA).

At 1711, an AIoT service request initiation is performed. The Ambient IoT service is triggered by the AF 1708, which requests Ambient IoT device discovery and/or inventory, via the NEF 1707.

At 1712, an AIoTF selection is performed. The NEF 1707 selects one or more appropriate AIoTFs (e.g., the AIoTF 1705) based on a target area.

At 1713, communication is established with the one or more AIoTFs (e.g., the AIoTF 1705). The NEF 1707 invokes the Naiotf_AIoT_Inventory service operation towards each of the one or more selected AIoTFs (e.g., the AIoTF 1705).

At 1714, an inventory request and a candidate UE reader list may be generated. The AIoTF 1705 performs service authorization and retrieves relevant subscription and service context, interacting with the ADM, UDM and/or AMF. The inventory request and/or the candidate UE reader list include an indication that indirect access via UE readers is required.

The AIoTF 1705 generates an inventory request and determines the candidate list of the UE readers capable of functioning as the AMP AP STAs for Wi-Fi ambient devices. The AIoTF 1705 checks for each candidate UE, if that UE is allowed to operate as a UE reader for the Wi-Fi AIoT devices through the UDM 1709 and/or the AMF 1704, and the reader availability through the AMF 1704. Unlike the baseline in 3GPP TS 22.369, where readers may be purely cellular, the selection in FIG. 17 explicitly considers Wi-Fi capabilities, location, and/or 802.11 ambient IoT support.

At 1715, an inventory response is sent to the NEF 1707. The AIoTF 1705 sends the AIoT inventory service response to the NEF 1707 containing the accept or reject result for the AIoT service operation request based on 1714.

At 1716, the inventory response is sent to the AF 1708. The NEF 1707 sends the AIoT service operation response to the AF 1708. The inventory response includes the accept or reject result for the AIoT service operation request.

At 1717, an inventory request is sent to the UE reader device 1702. The AIoTF 1705 sends the inventory request message including AIoT identification information and one or more security parameters determined in 1714 to be included in a paging message, and assistance information to the selected UE reader device 1702. One or more messages between the AIoTF 1705 and the UE reader device 1702 are delivered using RRC between the UE 1702 and the NG-RAN 1703, the NGAP between the NG-RAN 1703 and the AMF 1704, and an SBI interface between the AMF 1704 and the AIoTF 1705, as shown in the protocol stack in FIG. 17.

At 1718, the inventory response is sent to the AIoTF 1705. The UE reader device 1702 sends the inventory response to the AIoTF 1705 indicating that the inventory request is received successfully and will perform the AIoT service operation.

At 1719, the inventory procedure is performed over 802.11 signaling. The UE reader device 1702 configures its IEEE 802.11 AMP AP STA functionality to perform the Ambient IoT inventory operation with the AIoT devices (AMP non-AP STAs, e.g., the AIoT device 1701), including energy emission, listening windows, and/or decoding parameters for Wi-Fi backscatter and/or ambient signaling using one or more AMP PPDUs.

At 1720, an inventory report is sent to the AIoTF 1705. The UE reader device 1702 sends one or more inventory report messages to the AIoTF 1705 including the one or more AIOT NAS messages from the one or more AIoT devices (AMP non-AP STAs, e.g., the AIoT device 1701).

At 1721, the device profile data is retrieved. The AIoTF 1705 retrieves an AIoT device profile and/or metadata from the ADM 1706 and/or the UDM 1709, correlating one or more received identifiers with stored device information. In an example, the step 1721 is triggered by data obtained indirectly via the UE reader device 1702.

At 1722, an AIoT session release procedure is performed.

Upon completion of the inventory or data collection, the AIoT session between the UE reader device 1702 and the AIoTF 1705 is released. The UE reader device 1702 tears down any temporary Wi-Fi ambient operation context.

At 1723, an inventory output is sent to the NEF 1707. The AIoTF 1705 reports the collected AIoT data and results to the NEF 1707.

At 1724, the inventory output is sent to the AF 1708. The NEF 1707 provides the inventory output to the AF 1708.

In an implementation, one or more service logic, core network functions, and/or application interfaces may be based on a 3GPP framework. In an implementation, there are one or more differences between the AIoT inventory procedure of the present disclosure and the 3GPP framework. In the AIoT inventory procedure of the present disclosure, the AIoT device may not establish a direct cellular link. Instead, all Ambient IoT procedures associated with the AIoT device may be executed over IEEE 802.11 via a UE reader device that bridges Wi-Fi ambient signaling to the cellular core, enabling Wi-Fi-based Ambient IoT devices to be fully integrated into the 3GPP framework.

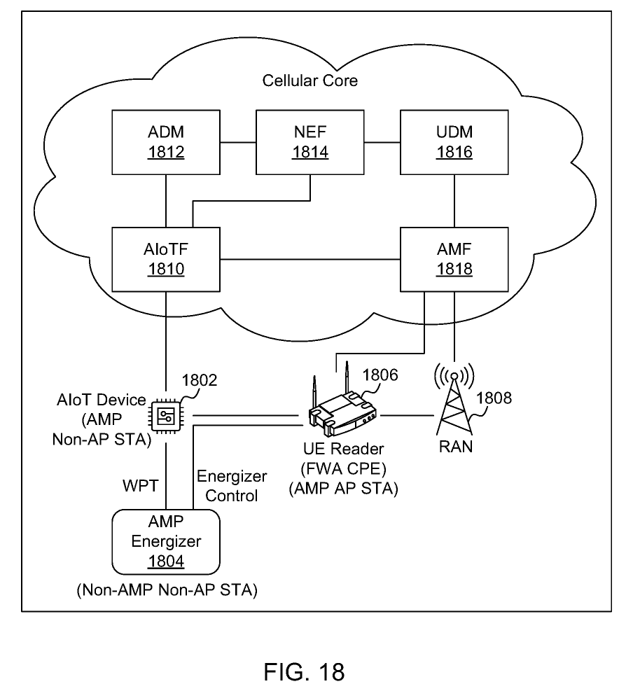

Referring now to FIG. 18, a schematic block diagram of communication between a cellular UE reader device and a Wi-Fi AMP device using an AMP energizer is shown according to one or more implementations of the present disclosure. FIG. 18 shows an AIoT device 1802, an AMP energizer 1804, a UE reader device 1806, a RAN 1808, an AIoTF 1810, an ADM 1812, a NEF 1814, a UDM 1816, and an AMF 1818.

In FIG. 18, the AMP energizer 1804 incorporates an energizing function capable of transmitting WPT waveforms and/or excitation waveforms for backscattering operation. The AMP energizer 1804 may include or be co-located with a non-AMP non-AP STA. The AMP energizer 1804 provides energy to the AIoT device 1802 (AMP non-AP STA) and, where applicable, a carrier signal and/or an excitation signal required for backscatter-based communication. In an example, the UE reader device 1806 and the AMP energizer 1804 enable Wi-Fi–based Ambient IoT devices to participate fully in a cellular Ambient IoT ecosystem.

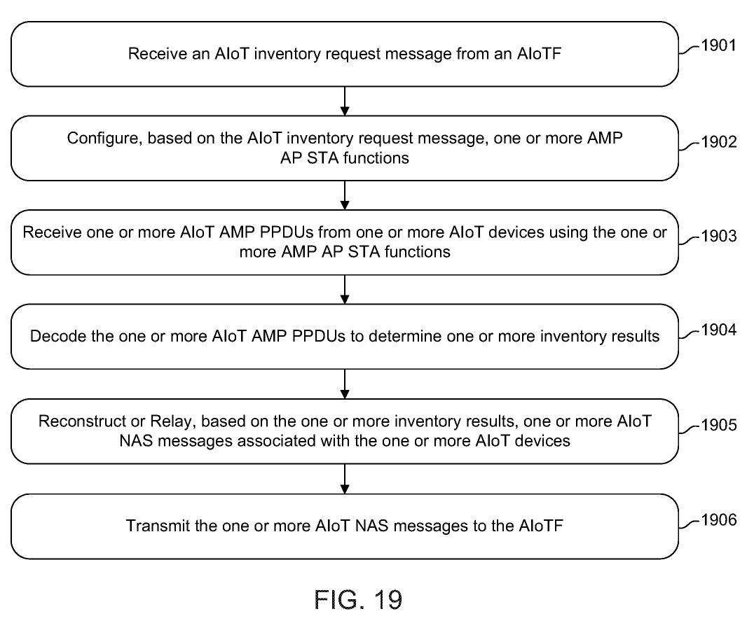

Referring now to FIG. 19, a flowchart illustrating a method performed by a UE is shown according to one or more implementations of the present disclosure.

At 1901, the UE receives an AIoT inventory request message from an AIoTF. In an implementation, the UE communicates with the AIoTF via: an RRC signaling between the UE and a NG-RAN, a NGAP between the NG-RAN and an AMF, and an SBI between the AMF and the AIoTF. In an implementation, wherein the AIoT inventory request message comprises: listening window configuration information, energy emission configuration information, one or more decoding parameters associated with the one or more AIoT signals, or identification information associated with the one or more AIoT devices.

At 1902, the UE configures, based on the AIoT inventory request message, one or more AMP AP STA functions.

At 1903, the UE receives one or more AIoT AMP PPDUs from one or more AIoT devices using the one or more AMP AP STA functions. In an implementation, the UE communicates with the one or more AIoT devices using Wi-Fi AMP signaling or backscatter signaling.

At 1904, the UE decodes the one or more AIoT AMP PPDUs to determine one or more inventory results.

At 1905, the UE reconstructs, based on the one or more inventory results, one or more AIoT NAS messages associated with the one or more AIoT devices. In an embodiment, the UE relays the one or more AIoT NAS messages received from the one or more AIoT devices.

At 1906, the UE transmits the one or more AIoT NAS messages to the AIoTF.

In an implementation, the UE terminates a Wi-Fi MAC layer and PHY layer for the one or more AIoT devices.

In an implementation, the method further comprises receiving one or more commands from the AIoTF via RRC signaling. The method further comprises transmitting the one or more commands to the one or more AIoT devices via Wi-Fi AMP signaling or backscatter signaling.

In an implementation, the commands are indicative of performing, on the one or more AIoT devices, one or more of: an inventory operation, a read operation, a write operation, or a disable operation.

In an implementation, the method further comprises configuring an AMP energizer to transmit one or more WPT waveforms or one or more excitation waveforms to the one or more AIoT devices to enable backscatter signaling.

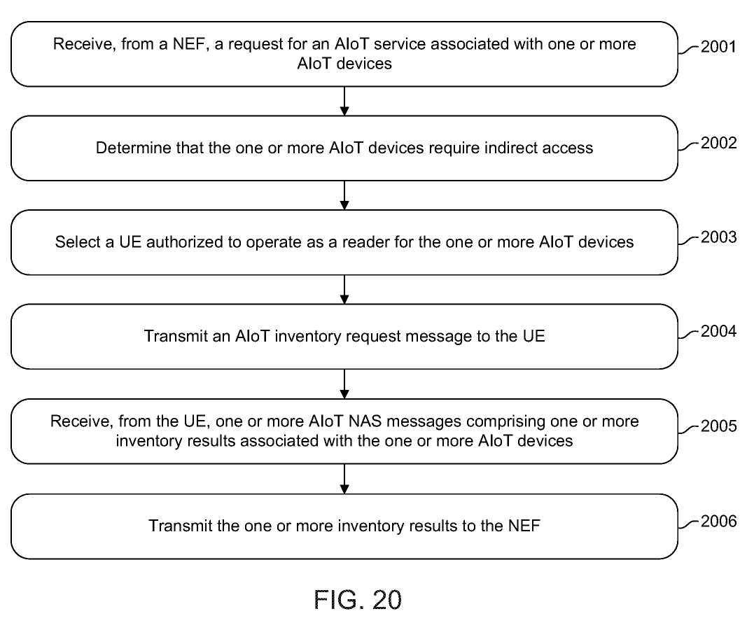

Referring now to FIG. 20, a flowchart illustrating a method performed by an AIoTF is shown according to one or more implementations of the present disclosure.

At 2001, the AIoTF receives, from a NEF, a request for an AIoT service associated with one or more AIoT devices.

At 2002, the AIoTF determines that the one or more AIoT devices require indirect access.

At 2003, the AIoTF selects a UE authorized to operate as a reader for the one or more AIoT devices.

At 2004, the AIoTF transmits an AIoT inventory request message to the UE. In an implementation, the AIoT inventory request message comprises: listening window configuration information, energy emission configuration information, one or more decoding parameters associated with one or more AIoT signals, or identification information associated with the one or more AIoT devices.

At 2005, the AIoTF receives, from the UE, one or more AIoT NAS messages comprising one or more inventory results associated with the one or more AIoT devices.

At 2006, the AIoTF transmits the one or more inventory results to the NEF.

In an implementation, the AIoTF retrieves AIoT device profile information from a UDM or ADM. The AIoTF generates the AIoT inventory request message based on the AIoT device profile information.

What is claimed is:

1. A method performed by a user equipment (UE), the method comprising:
receiving an ambient internet of things (AIoT) inventory request message from an AIoT function (AIoTF);
configuring, based on the AIoT inventory request message, one or more ambient power (AMP) access point (AP) station (STA) functions;
receiving one or more AIoT AMP physical layer protocol data units (PPDUs) from one or more AIoT devices using the one or more AMP AP STA functions;
decoding the one or more AIoT AMP PPDUs to determine one or more inventory results;
reconstructing or relaying, based on the one or more inventory results, one or more AIoT non-access stratum (NAS) messages associated with the one or more AIoT devices; and
transmitting the one or more AIoT NAS messages to the AIoTF.

2. The method of claim 1, wherein the UE communicates with the AIoTF via:
a radio resource control (RRC) signaling between the UE and a next-generation radio access network (NG-RAN),
a next-generation application protocol (NGAP) between the NG-RAN and an access and mobility management function (AMF), and
a service-based interface (SBI) between the AMF and the AIoTF.

3. The method of claim 1, wherein the UE communicates with the one or more AIoT devices using Wi-Fi AMP signaling or backscatter signaling.

4. The method of claim 1, wherein the AIoT inventory request message comprises:
listening window configuration information,
energy emission configuration information,
one or more decoding parameters associated with one or more AIoT signals, or
identification information associated with the one or more AIoT devices.

5. The method of claim 1, wherein the UE terminates a Wi-Fi medium access control (MAC) layer and physical (PHY) layer for the one or more AIoT devices.

6. The method of claim 1, further comprising:
receiving one or more commands from the AIoTF via RRC signaling; and
transmitting the one or more commands to the one or more AIoT devices via Wi-Fi AMP signaling or backscatter signaling.

7. The method of claim 6, wherein the commands are indicative of performing, on the one or more AIoT devices, one or more of:
an inventory operation,
a read operation,
a write operation, or
a disable operation.

8. The method of claim 1, further comprising:
configuring an AMP energizer to transmit one or more wireless power transfer (WPT) waveforms or one or more excitation waveforms to the one or more AIoT devices to enable backscatter signaling.

9. A user equipment (UE), comprising:
a transceiver; and
a processor, wherein the transceiver and the processor are configured to:
receive an ambient internet of things (AIoT) inventory request message from an AIoT function (AIoTF),
configure, based on the AIoT inventory request message, one or more ambient power (AMP) access point (AP) station (STA) functions,
receive one or more AIoT AMP physical layer protocol data units (PPDUs) from one or more AIoT devices using the one or more AMP AP STA functions,
decode the one or more AIoT AMP PPDUs to determine one or more inventory results,
reconstruct or relay, based on the one or more inventory results, one or more AIoT non-access stratum (NAS) messages associated with the one or more AIoT devices, and
transmit the one or more AIoT NAS messages to the AIoTF.

10. The UE of claim 9, wherein the UE communicates with the AIoTF via:
a radio resource control (RRC) signaling between the UE and a next-generation radio access network (NG-RAN),
a next-generation application protocol (NGAP) between the NG-RAN and an access and mobility management function (AMF), and
a service-based interface (SBI) between the AMF and the AIoTF.

11. The UE of claim 9, wherein the UE communicates with the one or more AIoT devices using Wi-Fi AMP signaling or backscatter signaling.

12. The UE of claim 9, wherein the AIoT inventory request message comprises:
listening window configuration information,
energy emission configuration information,
one or more decoding parameters associated with one or more AIoT signals, or
identification information associated with the one or more AIoT devices.

13. The UE of claim 9, wherein the UE terminates a Wi-Fi medium access control (MAC) layer and physical (PHY) layer for the one or more AIoT devices.

14. The UE of claim 9, wherein the transceiver and the processor are configured to:
receive one or more commands from the AIoTF via RRC signaling; and
transmit the one or more commands to the one or more AIoT devices via Wi-Fi AMP signaling or backscatter signaling.

15. The UE of claim 14, wherein the commands are indicative of performing, on the one or more AIoT devices, one or more of:
an inventory operation,
a read operation,
a write operation, or
a disable operation.

16. The UE of claim 9, wherein the transceiver and the processor are further configured to:
configure an AMP energizer to transmit one or more wireless power transfer (WPT) waveforms or one or more excitation waveforms to the one or more AIoT devices to enable backscatter signaling.

17. A method performed by a network device, the method comprising:
receiving, from a network exposure function (NEF), a request for an ambient internet of things (AIoT) service associated with one or more AIoT devices;
determining that the one or more AIoT devices require indirect access;
selecting a user equipment (UE) authorized to operate as a reader for the one or more AIoT devices;
transmitting an AIoT inventory request message to the UE;
receiving, from the UE, one or more AIoT non-access stratum (NAS) messages comprising one or more inventory results associated with the one or more AIoT devices; and
transmitting the one or more inventory results to the NEF.

18. The method of claim 17, wherein the AIoT inventory request message comprises:
listening window configuration information,
energy emission configuration information,
one or more decoding parameters associated with one or more AIoT signals, or
identification information associated with the one or more AIoT devices.

19. The method of claim 17, further comprising:
retrieving AIoT device profile information from a unified data management (UDM) or AIoT data management (ADM); and
generating the AIoT inventory request message based on the AIoT device profile information.

20. The method of claim 17, wherein the network device functions as an AIoT function (AIoTF).
